(19) United States
(12) Patent Application Publication
(10) Pub. No.: US 2013/0139527 A1
(43) Pub. Date: Jun. 6, 2013

(54) Method for Controlling a Heating and Air Conditioning System in a Vehicle

(71) Applicant: BAYERISCHE MOTOREN WERKE AKTIENGESELLSCHAFT, Muenchen (DE)

(72) Inventors: Mattias BRUCE, Muenchen (DE); Michael HEIL, Forstinning (DE); Robert SALZBERGER, Muenchen (DE)

(73) Assignee: BAYERISCHE MOTOREN WERKE AKTIENGESELLSCHAFT, Muenchen (DE)

(21) Appl. No.: 13/753,160

(22) Filed: Jan. 29, 2013

Related U.S. Application Data
(63) Continuation of application No. PCT/EP2011/062017, filed on Jul. 14, 2011.

(30) Foreign Application Priority Data
Jul. 30, 2010 (DE) 10 2010 038 682.0

(51) Int. Cl. B60H 1/00; F25D 21/00

(52) U.S. Cl. CPC B60H 1/00642
USPC 62/80

(57) ABSTRACT

A method is provided for controlling a heating and air conditioning system in a vehicle. The evaporator of the air conditioner is switched off below a predefined external temperature threshold in order to prevent the risk of icing. The external temperature threshold for switching off the evaporator as a function of the external temperature, is also defined, preferably variably, below the freezing point.

### CROSS REFERENCE TO RELATED APPLICATIONS

This application is a continuation of PCT International Application No. PCT/EP2011/062017, filed Jul. 14, 2011, which claims priority under 35 U.S.C. §119 from German Patent Application No. DE 10 2010 038 682.0, filed Jul. 30, 2010, the entire disclosures of which are herein expressly incorporated by reference.

### BACKGROUND AND SUMMARY OF THE INVENTION

The present invention relates to a method for controlling a heating and air-conditioning system in a vehicle, wherein the evaporator of the air conditioner is switched off below a predefined outside temperature threshold in order to prevent the risk of icing.

A method of this type is described, for example, in German Patent document DE 195 22 666 A1, the focus in this case being the controlling of the heating and air-conditioning system in the form of a switch-off strategy of the air-conditioning compressor (evaporator) in order to prevent evaporator icing. It is known that moisture is deposited on an evaporator of a vehicle air conditioner through which a refrigerant flows, which moisture is contained in the air current flowing through the evaporator. If the temperature of the air flowing through the evaporator approaches the freezing point of water because of low ambient temperatures, the refrigerant circuit, i.e. particularly the air-conditioning compressor, on known vehicle air conditioners will be switched off by suitable temperature switches or sensors in order to prevent an icing of the evaporator that would impair the operability of the air conditioner.

In particular, the operability of an air-conditioner also is to be ensured for preventing a steaming-up of windows. The applicant's German Patent Application 10 2010 003070.8, which is not a prior publication, describes measures for preventing a steaming-up of windows by correspondingly controlling the heating and air-conditioning system. The content of German Patent Application 10 2010 003070.8 is expressly incorporated by reference herein.

A contemplated construction of an air conditioner is indicated, for example, in German Patent document DE 196 50 942 A1.

In the meantime, large numbers of all new vehicles are being equipped with an air conditioner that can be switched on and off by the driver through use of a push button. In the case of vehicles that have a personalized access system, among others, the switching state or the activity state of the air conditioner can be stored in a personalized manner, so that the air conditioner is automatically switched on or off as a function of the driver's adjustment as soon as the person was identified as the driver (for example, as a result of the insertion of a key).

As a result of a driver change, it may happen that the air conditioner was activated in the case of the preceding driver and is deactivated in the case of the current driver. In such cases, it is possible that, under certain environmental conditions, a considerable steaming-up of the windows may occur at the start of the drive or during the drive and can no longer be eliminated (or can be eliminated only very slowly) without the aid of the air conditioner. The steaming-up is first reinforced by the switched-off air conditioner because the condensation water accumulated at the evaporator can no longer be held and is continuously returned to the air in the air conditioner. The same initial conditions also cause a steaming-up during the drive if the air conditioner is switched off during the drive. However, as a rule, the steaming-up will then occur with a slight time lag, so that the user can no longer comprehend the connection with the switched-off air conditioner. Likewise, the windows may also steam up when, for example, moisture was introduced into the vehicle interior.

Currently, various measures are carried out for detecting an imminent steaming-up of the windows as well as for preventing or for reducing the steaming-up. Thus, vehicles are known that are equipped with a window steam-up sensor or a moisture sensor in the vehicle interior, by means of which, while taking into account environmental conditions, the steam-up risk for the windows is monitored. When an imminent steaming-up of the windows is detected or assumed, various measures are automatically initiated for preventing the steaming-up of the windows by a corresponding controlling of the automatic heating and air-conditioning system. Thus, for example, the recirculated-air function is deactivated (or is switched from the air recirculation to the fresh-air mode) and corresponding flaps are opened for defrosting the windows, the fan power is raised, and/or the desired temperature is increased.

Under extremely unfavorable environmental conditions, the above-mentioned measures may not be sufficient for preventing steaming-up or for eliminating the steaming-up that has already occurred.

An object of the invention is to provide a method by which an imminent steaming-up of windows can be counteracted even better then past measures.

This and other objects are achieved by a method according to the invention for controlling a heating and air-conditioning system in a vehicle, wherein the evaporator of the air conditioner is switched off below a predefined outside temperature threshold in order to prevent a risk of icing. The outside temperature threshold for switching off the evaporator as a function of the outside temperature—preferably variably—is also predefined below the freezing point. In principle, the minimal outside temperature threshold is to be adapted to the lowest possible refrigerant flow rate in order to still ensure a sufficient controlling stability. A particularly advantageous range for the possibly also variable outside temperature threshold is approximately the range of from −5° C. to +2° C.

In this case, the refrigerant circuit is controlled, for example, by way of a characteristic curve such that the evaporator temperature always follows the level of the outside temperature. As a result, on the one hand, a basic dehumidification continues to be maintained by holding the water accumulated at the evaporator and, on the other hand, icing continues to be prevented. The reason is that no additional water is precipitated or no water is released into the intake paths in front of the evaporator by the typical heating of air. The evaporator thereby remains in equilibrium. Since the air moisture considerably decreases anyhow at temperatures of approximately −5° C., the operation of the air conditioner will no longer be required for preventing the steaming-up for colder outside temperatures.

As a result of the invention, the availability of the evaporator is increased and thereby also the possibilities of preventing a steaming-up.

In an advantageous embodiment of the invention, the evaporator and, therefore, the air conditioner, are automatically activated for initiating steam-up prevention measures if a steaming-up is imminent when the outside temperature is higher than the predefined variable outside temperature threshold.

The invention is preferably combined with the method of operating a heating and air-conditioning system in a vehicle described in the applicant's German Patent document 10 2010 003070.8, which method counteracts an imminent steaming-up by initiating various predefined steam-up prevention measures (as, for example, those described above). The imminent steaming-up can be determined by analyzing different sensor signals (steam-up sensor, temperature sensors, moisture sensors) or by way of calculated values.

The invention is further characterized in that, when an imminent steaming-up is detected on the vehicle windows, the steam-up prevention measures to be initiated are predefined as a function of the current switching condition or activity condition of the air conditioner and of the switching condition of the air conditioner within a preceding time interval. As a result of the analysis of the preceding switching condition of the air conditioner, an indirect conclusion may possibly also be drawn concerning the cause of the imminent steaming-up of the windows. When it is detected, for example, that the air conditioner had recently still been active, it may be assumed that the water adhering to the evaporator is at least jointly responsible for the imminent steaming-up of the windows.

Advantageously, the current switching condition and the past switching condition of the air conditioner are taken into account such that, when initiating the steam-up prevention measures, in the case of an imminent steaming-up and an originally (within the preceding time interval) switched-on air conditioner and a currently switched-off air conditioner, the air conditioner is automatically activated as a steam-up prevention measure.

However, if it is determined in the case of an imminent steaming-up of windows and while the air conditioner is currently switched off that the air conditioner was not also active in the analyzed preceding time interval, it is assumed that the known measures for preventing a steaming-up are sufficient; i.e. in the case of an originally not switched-on air conditioner and also a currently switched-off air conditioner, first only the other measures are initiated as steam-up prevention measures, and the air conditioner is not automatically activated. However, if it is determined after the initiation of other measures that these measures are not sufficient for preventing or eliminating the steaming-up of the windows (but simultaneously, in the case of a longer demand, also impair the climate comfort in the interior), in a second step, after the initiation of the other measures, the air conditioner may also still be activated.

If the air conditioner is automatically activated within the scope of the steam-up prevention measures (although no request is present from the driver with respect to an active air conditioner), at the time of the conclusion of the steam-up prevention measures, the air conditioner is slowly deactivated according to a predefined slope, so that it is not noticed or hardly noticed by the driver. In order to irritate the driver as little as possible, it is meaningful to also not activate a reference indicating the activity condition of the air conditioner even if the air conditioner was temporarily automatically activated as the steam-up prevention measure.

In addition, the method according to the invention as well as its advantageous embodiments can be carried out by way of an implemented algorithm or a corresponding module arrangement in a control device provided for this purpose, particularly an air-conditioning control device.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is an exemplary flow chart for operating a heating and air-conditioning system for preventing a steaming-up of windows in accordance with the invention; and

FIG. 2 is a view of a variably predefined outside temperature threshold in the form of a characteristic curve.

### DETAILED DESCRIPTION OF THE DRAWINGS

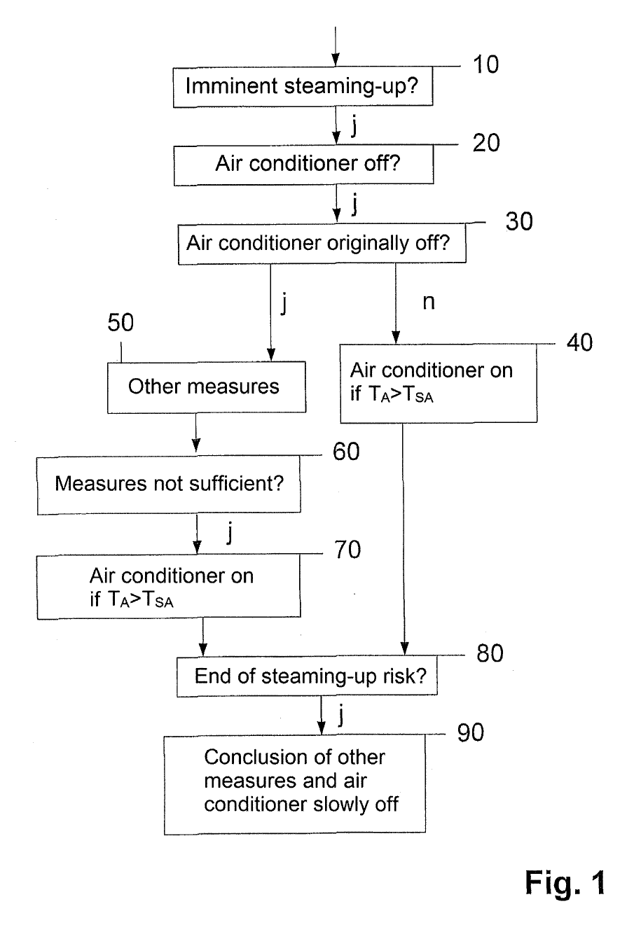

The flow chart in FIG. 1 starts in Step 10 as soon as it is detected by way of different sensor signals, for example, the signal of a steam-up sensor, that a steaming-up of the windows in the vehicle is imminent. When an imminent steaming-up is detected, it is checked in the next Step 20 whether the air conditioner is currently switched off. If this is true, it is still checked in the next Step 30 whether the air conditioner was switched on or active within a time interval before the current point-in-time.

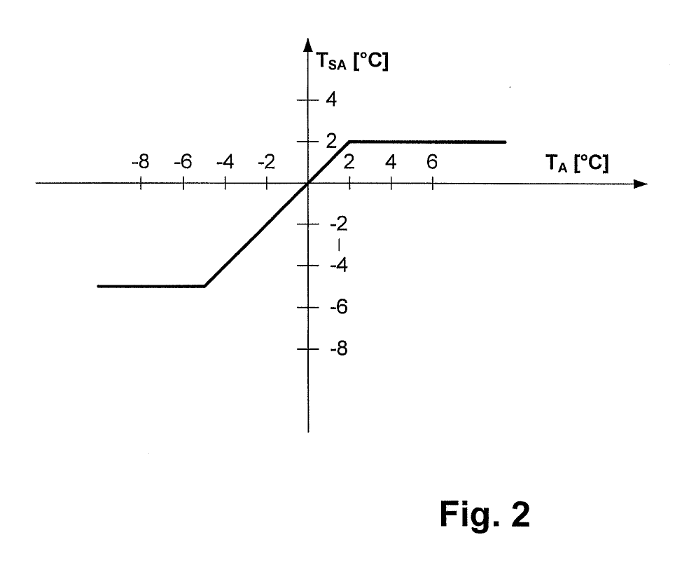

If, while the air conditioner is currently switched off, the system now detects that the air conditioner was operated beforehand within the time interval, the air conditioner (or the evaporator) is automatically switched on in Step 40 when the danger of a steaming-up is detected, if the outside temperature T_{A} is above the predefined outside temperature threshold T_{SA} according to the characteristic curve, which here is predefined in FIG. 2. Subsequently, the operation moves to Step 80. However, if it is detected at Step 30 that the air conditioner had not been operating beforehand within the time interval, in a first Step 50, only conventional measures for preventing a steaming-up of the windows are initiated, i.e. the air conditioner is not activated. Subsequently, the operation moves to the next Step 60.

If the system now detects in Step 60 that the available measures for preventing a steaming-up or for eliminating a steaming-up, which, in the case of an extended demand also impair the climate comfort in the vehicle interior, are not capable of preventing or eliminating the steaming-up, the air conditioner is also automatically started in the next Step 70 when the outside temperature T_{A} is above the predefined outside temperature threshold T_{SA} according to the characteristic curve predefined here in FIG. 2. Subsequently, the operation moves to Step 80.

As soon as it is determined in Step 80 by way of the sensor signals that a steaming up of the windows is no longer imminent or that the steaming-up was eliminated, the operation of the air conditioner will gradually (according to a predefined slope) be stopped, and, if required, the other measures will be deactivated, so that the original condition is restored.

FIG. 2 illustrates a predefined variable outside temperature threshold T_{SA} in the form of a characteristic curve as a function of the outside temperature T_{A}, which is also below the freezing point of approximately from 0° C. to 2° C., as an absolute switch-off criterion for the air conditioner or the evaporator. The minimal outside temperature threshold T_{SAmin} of, in this case, approximately −5° C. is not least predefined in that the air moisture at this outside temperature is low anyhow. In principle, the minimal outside temperature threshold T_{SAmin} is to be limited corresponding to the lowest-possible controllable refrigerant flow rate of each air conditioner in order to still ensure sufficient controlling stability.

The method according to the invention results in several advantages. It can be considered to be a significant advantage that an icing of the evaporator is still avoided, and nevertheless a bothersome steaming-up of the windows (or at least a complete steaming-up of the windows), which may be caused, for example, as a result of a previously active air conditioner, can be prevented. As a result, it is avoided that customers become irritated by the otherwise occurring steaming-up phenomena, and the climate comfort is significantly improved because the driver himself does not have to intervene in the climate control. Furthermore, unpleasant odors are also prevented, which may occur as a result of residual moisture in the evaporator.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling a heating and air-conditioning system in a vehicle, the method comprising the acts of:
switching-off an evaporator of the air conditioner below a predefined outside temperature threshold in order to prevent risk of icing; wherein
the predefined outside temperature threshold for switching off the evaporator is also predefined below a freezing point.

2. The method according to claim 1, wherein the predefined outside temperature threshold is variably predefined approximately in a range of from −5° C. to +2° C.

3. The method according to claim 1, further comprising the act of:
automatically activating the evaporator and consequently, the air conditioner, for initiating steam-up prevention measures if a steaming-up of a window in the vehicle is imminent when an outside temperature is higher than the predefined outside temperature threshold.

4. The method according to claim 3, further comprising the act of:
activating the evaporator and, consequently, the air conditioner, for initiating steam-up prevention measures if a steaming-up of a window in the vehicle is imminent also as a function of a switching condition of the air conditioner within a predefined time interval.

5. The method according to claim 4, further comprising the act of:
initiating other measures for preventing the steaming-up in addition to the activation of the air conditioner.

6. The method according to claim 4, wherein, in case of an originally not switched-on air conditioner within the preceding time interval and also a currently switched-off air conditioner, initially initiating only other measures as steam-up prevention measures before the air conditioner is to be automatically activated.

7. The method according to claim 6, wherein, in the case of the originally not switched-on air conditioner within the preceding time interval and also the currently switched-off air conditioner, secondly automatically activating the air conditioner after the initiation of the other steam-up prevention measures if the other steam-up prevention measures are insufficient to prevent a steaming-up of the window.

8. The method according to claim 7, wherein, when the steam-up prevention measures have concluded, slowly deactivating the air conditioner as a function of a predefined slope.

9. The method according to claim 5, wherein the other measures for preventing a steaming-up include at least one of:
deactivating a recirculated-air function;
switching-over to a fresh-air mode;
opening flaps for defrosting the window;
increasing fan power; and
raising a desired temperature.
